(19) United States
(12) Patent Application Publication
(10) Pub. No.: US 2024/0282327 A1
(43) Pub. Date: Aug. 22, 2024

(54) SPEECH ENHANCEMENT USING PREDICTED NOISE

(71) Applicant: QUALCOMM Incorporated, San Diego, CA (US)

(72) Inventors: Asif MOHAMMAD, San Diego, CA (US); Fatemeh ALISHAHI, Los Angeles, CA (US); Maliha Arif ZAIN, Orlando, FL (US); Sajeer FAZIL, San Diego, CA (US)

(21) Appl. No.: 18/172,711

(22) Filed: Feb. 22, 2023

(51) Int. Cl. G10L 21/0232; G10L 15/16

(52) U.S. Cl. CPC G10L 21/0232; G10L 15/16

(57) ABSTRACT

A device includes one or more processors configured to obtain an input audio signal including at least first speech of a first person. The one or more processors are configured to generate a predicted noise signal based on processing of the input audio signal by a trained model. The one or more processors are configured to subtract the predicted noise signal from the input audio signal to generate an output audio signal.

### I. FIELD

The present disclosure is generally related to using predicted noise to enhance speech.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications such as a web browser application, that can be used to access the Internet. As such, these devices can include significant computing capabilities.

Such computing devices often incorporate functionality to receive an audio signal from one or more microphones. For example, the audio signal may represent user speech captured by the microphones, external sounds captured by the microphones, or a combination thereof. Speech enhancement can be performed to recover the user speech from a noisy audio signal.

### III. Summary

According to one implementation of the present disclosure, a device includes one or more processors configured to obtain an input audio signal including at least first speech of a first person. The one or more processors are configured to generate a predicted noise signal based on processing of the input audio signal by a trained model. The one or more processors are configured to subtract the predicted noise signal from the input audio signal to generate an output audio signal.

According to another implementation of the present disclosure, a method includes obtaining, at a device, an input audio signal including at least first speech of a first person. The method also includes generating, at the device, a predicted noise signal based on processing of the input audio signal by a trained model. The method also includes subtracting, at the device, the predicted noise signal from the input audio signal to generate an output audio signal.

According to another implementation of the present disclosure, a non-transitory computer-readable medium stores instructions that, when executed by one or more processors, cause the one or more processors to obtain an input audio signal including at least first speech of a first person. The instructions further cause the one or more processors to generate a predicted noise signal based on processing of the input audio signal by a trained model. The instructions further cause the one or more processors to subtract the predicted noise signal from the input audio signal to generate an output audio signal.

According to another implementation of the present disclosure, an apparatus includes means for obtaining an input audio signal including at least first speech of a first person. The apparatus also includes means for generating a predicted noise signal based on processing of the input audio signal by a trained model. The apparatus further includes means for subtracting the predicted noise signal from the input audio signal to generate an output audio signal.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform speech enhancement using predicted noise, in accordance with some examples of the present disclosure.

FIG. 2 is a block diagram of another illustrative aspect of a system operable to perform speech enhancement using predicted noise, in accordance with some examples of the present disclosure.

FIG. 3 is a block diagram of another illustrative aspect of a system operable to perform speech enhancement using predicted noise, in accordance with some examples of the present disclosure.

FIG. 4 is a block diagram of an illustrative aspect of a trained model of the system of FIG. 1, FIG. 2, or FIG. 3, in accordance with some examples of the present disclosure.

FIG. 5 is a diagram of an illustrative aspect of operation of components of the system of FIG. 1, FIG. 2, or FIG. 3, in accordance with some examples of the present disclosure.

FIG. 6 illustrates an example of an integrated circuit operable to perform speech enhancement using predicted noise, in accordance with some examples of the present disclosure.

FIG. 7 is a diagram of a mobile device operable to perform speech enhancement using predicted noise, in accordance with some examples of the present disclosure.

FIG. 8 is a diagram of a headset operable to perform speech enhancement using predicted noise, in accordance with some examples of the present disclosure.

FIG. 9 is a diagram of a wearable electronic device operable to perform speech enhancement using predicted noise, in accordance with some examples of the present disclosure.

FIG. 10 is a diagram of a voice-controlled speaker system operable to perform speech enhancement using predicted noise, in accordance with some examples of the present disclosure.

FIG. 11 is a diagram of a camera operable to perform speech enhancement using predicted noise, in accordance with some examples of the present disclosure.

FIG. 12 is a diagram of a headset, such as a virtual reality, mixed reality, or augmented reality headset, operable to perform speech enhancement using predicted noise, in accordance with some examples of the present disclosure.

FIG. 13 is a diagram of a hearing aid device operable to perform speech enhancement using predicted noise, in accordance with some examples of the present disclosure.

FIG. 14 is a diagram of earbuds operable to perform speech enhancement using predicted noise, in accordance with some examples of the present disclosure.

FIG. 15 is a diagram of a first example of a vehicle operable to perform speech enhancement using predicted noise, in accordance with some examples of the present disclosure.

FIG. 16 is a diagram of a second example of a vehicle operable to perform speech enhancement using predicted noise, in accordance with some examples of the present disclosure.

FIG. 17 is a diagram of a particular implementation of a method of perform speech enhancement using predicted noise that may be performed by a device of FIG. 1, FIG. 2, or FIG. 3 in accordance with some examples of the present disclosure.

FIG. 18 is a block diagram of a particular illustrative example of a device that is operable to perform speech enhancement using predicted noise, in accordance with some examples of the present disclosure.

### V. DETAILED DESCRIPTION

Preferred characteristics for denoised speech are typically very different for human listening consumption than for speech recognition engines. Human listeners focus on perceptual speech quality, whereas less distortion in the speech envelope improves performance of speech recognition engines.

Increasing noise removal in predicted speech can cause artifacts in the resulting denoised signal. Researchers have tried adding the original noisy signal back to the denoised signal to reduce artifacts. This does reduce speech artifacts as original speech is added back but noise is added as well, reducing the signal-to-noise ratio. Researchers have also tried targeted noise removal by explicitly targeting signal-to-noise ratio improvements. Invariably predicting or generating target speech results in artifacts and distortions to speech envelope that result in automatic speech recognition (ASR) performance degradation.

Systems and methods of speech enhancement using predicted noise are disclosed. For example, a speech enhancer uses a trained model to process an input audio signal to generate a predicted noise signal. In some examples, the predicted noise signal does not include any speech from the input audio signal. The speech enhancer filters the input audio signal based on the predicted noise signal to generate an output audio signal (e.g., a denoised speech signal) that preserves a speech envelope of the input audio signal. ASR performed on the output audio signal has higher accuracy as compared to ASR performed on the input audio signal or ASR performed on a predicted speech signal that is generated from (e.g., by applying a time frequency complex mask to) the input audio signal.

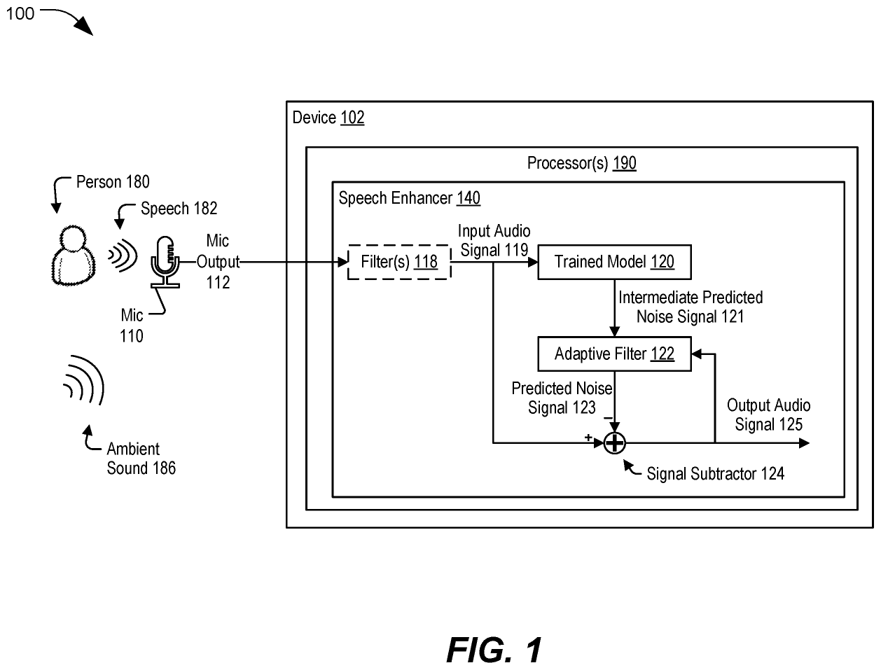

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described.

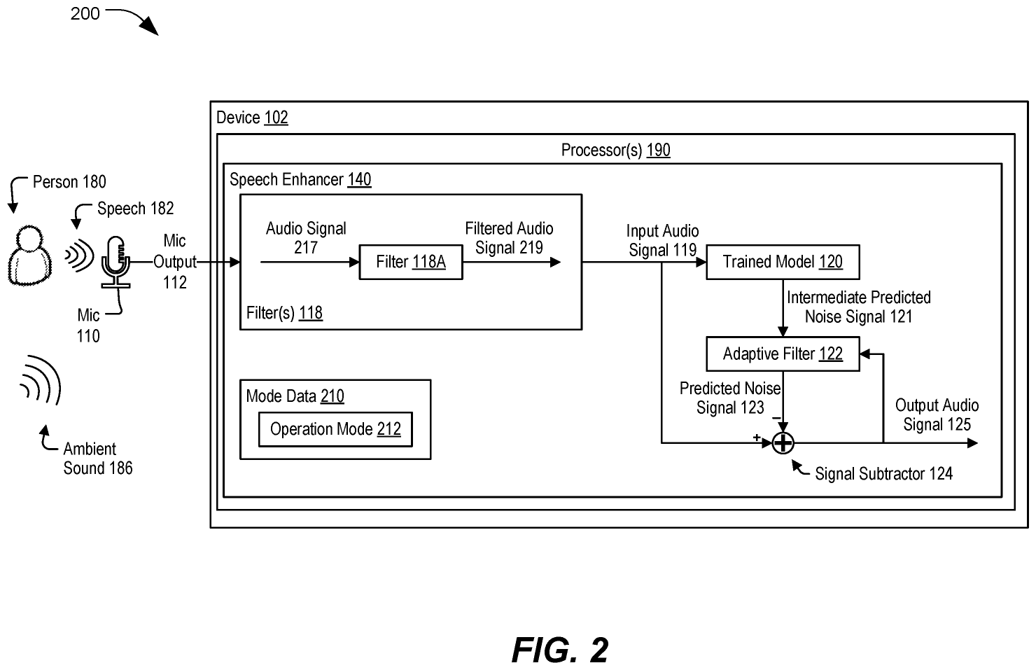

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 2, one or more filters 118 are illustrated. When referring to a particular one of these filters, such as a filter 118A, the distinguishing letter “A” is used. However, when referring to any arbitrary one of these filters or to these filters as a group, the reference number 118 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 configured to perform speech enhancement using predicted noise is disclosed. The system 100 includes a device 102 that is configured to be coupled to a microphone 110. The device 102 is configured to perform speech enhancement using predicted noise.

The device 102 includes one or more processors 190 that include a speech enhancer 140. The speech enhancer 140 includes a trained model 120 coupled via an adaptive filter 122 to a signal subtractor 124. In some implementations, the adaptive filter 122 includes a non-linear filter (e.g., an adaptive non-linear Wiener filter). In some implementations, the trained model 120 includes a neural network.

Optionally, in some implementations, the speech enhancer 140 includes one or more filters 118 coupled to the trained model 120 and to the signal subtractor 124. In some implementations, the one or more filters 118 include one or more linear filters (e.g., one or more finite impulse response (FIR) filters).

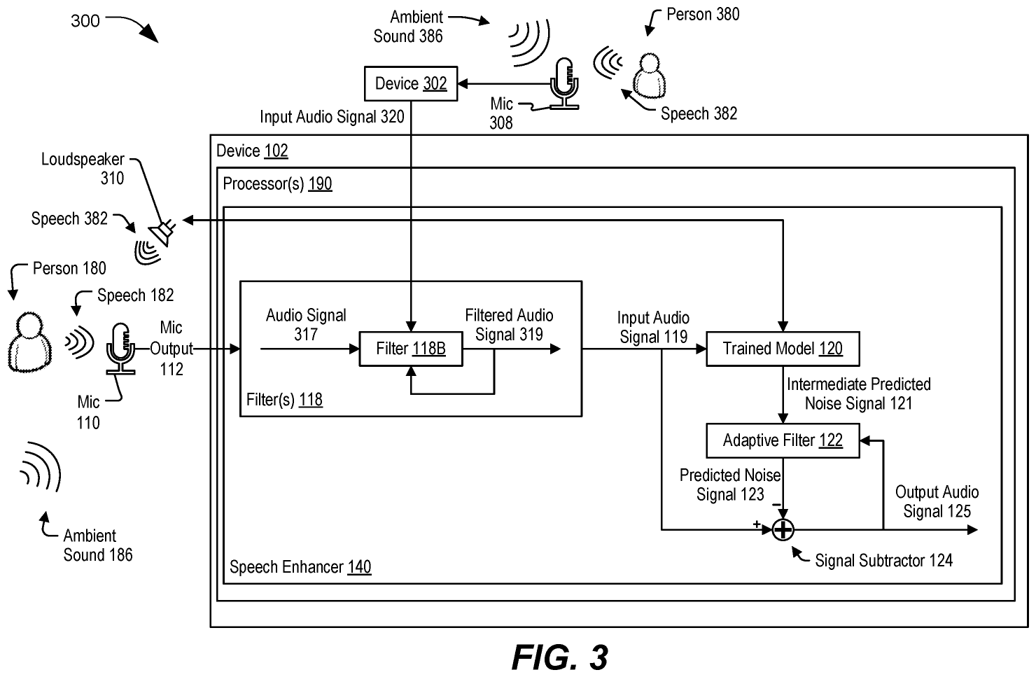

The speech enhancer 140 is configured to receive a microphone output signal 112 from the microphone 110. In some implementations in which the speech enhancer 140 includes the one or more filters 118, the speech enhancer 140 is configured to use the one or more filters 118 to process the microphone output signal 112 to generate an input audio signal 119, as further described with reference to FIGS. 2 and 3. The one or more filters 118 are configured to provide the input audio signal 119 to the trained model 120 and to the signal subtractor 124. In some implementations (e.g., in which the speech enhancer 140 does not include the one or more filters 118), the speech enhancer 140 provides the microphone output signal 112 as the input audio signal 119 to the trained model 120 and to the signal subtractor 124.

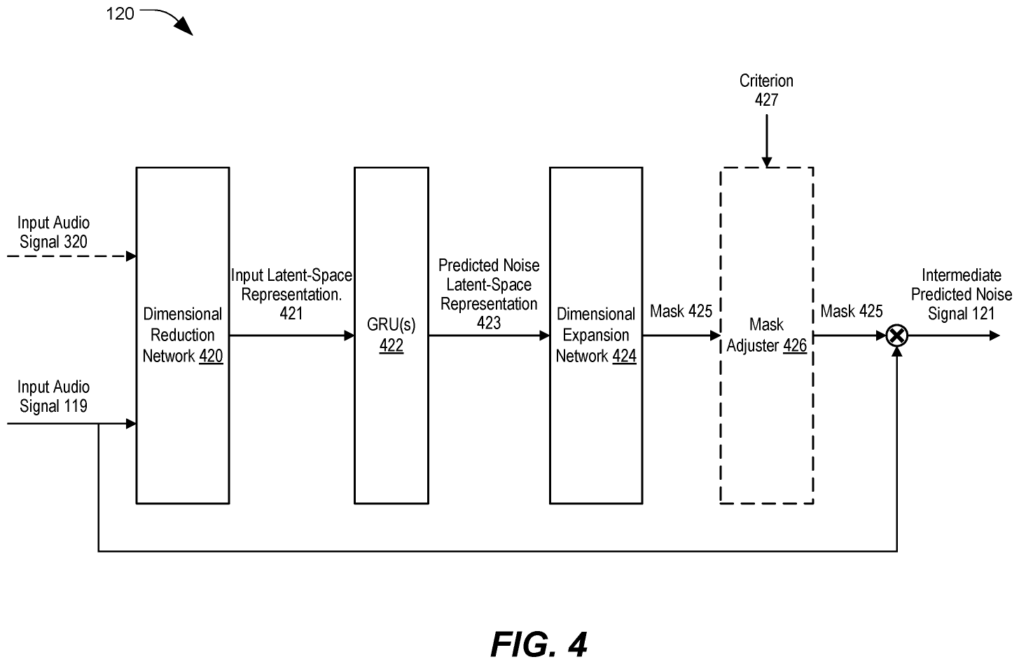

The speech enhancer 140 is configured to use the trained model 120 to process an input audio signal (e.g., the input audio signal 119) to generate a predicted noise signal (e.g., an intermediate predicted noise signal 121), as further described with reference to FIG. 4. In some aspects, during training, the trained model 120 is used to process training audio (e.g., including speech and pre-determined noise) to generate predicted noise. A loss metric is determined based on a comparison of the pre-determined noise and the predicted noise, and the trained model 120 is updated (e.g., weights and biases are adjusted) based on the loss metric. In some examples, training of the trained model 120 is considered complete when the loss metric is less than a threshold, at least a threshold count of training iterations have been performed, or both.

The speech enhancer 140 is configured to use the adaptive filter 122 to process at least the intermediate predicted noise signal 121 to generate a predicted noise signal 123. The signal subtractor 124 is configured to generate an output audio signal 125 based on a difference between the input audio signal 119 and the predicted noise signal 123. For example, the signal subtractor 124 is configured to subtract the predicted noise signal 123 from the input audio signal 119 to generate the output audio signal 125.

In a particular aspect, the speech enhancer 140 is configured to use the output audio signal 125 as feedback to the adaptive filter 122. For example, the adaptive filter 122 is configured to use a portion of the output audio signal 125 to process a subsequent portion of the intermediate predicted noise signal 121 to generate a subsequent portion of the predicted noise signal 123.

The trained model 120 is trained to generate the intermediate predicted noise signal 121 such that the intermediate predicted noise signal 121 (and thus the predicted noise signal 123) includes less, if any, speech of the input audio signal 119. Hence, the output audio signal 125 retains more of the speech envelope of the input audio signal 119. A technical advantage of using the trained model 120 can thus include improved accuracy of subsequent speech processing (e.g., by a speech recognition engine) of the output audio signal 125.

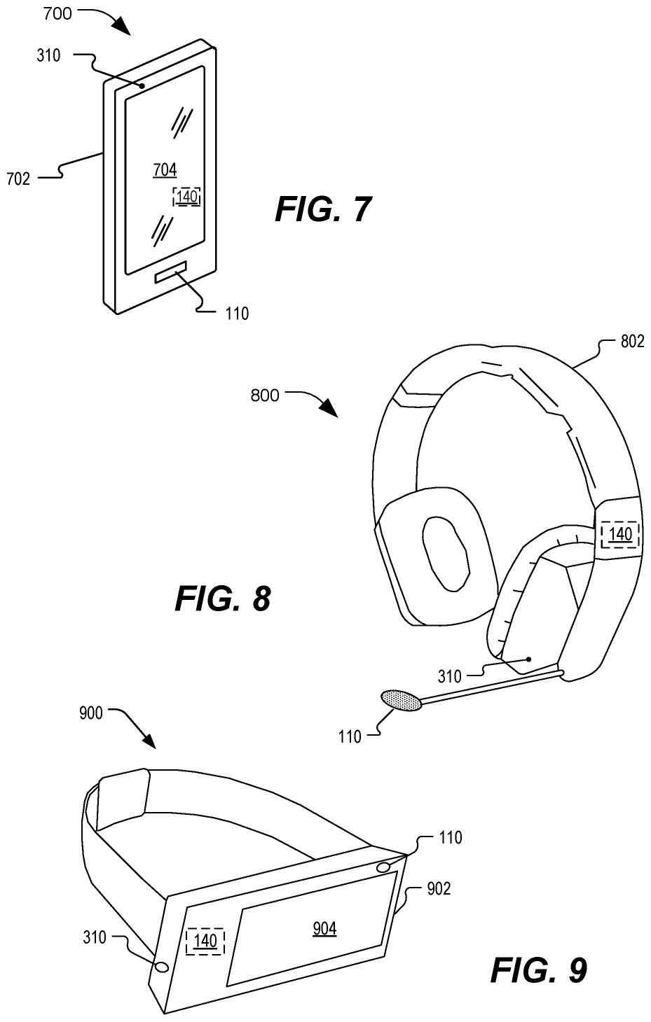

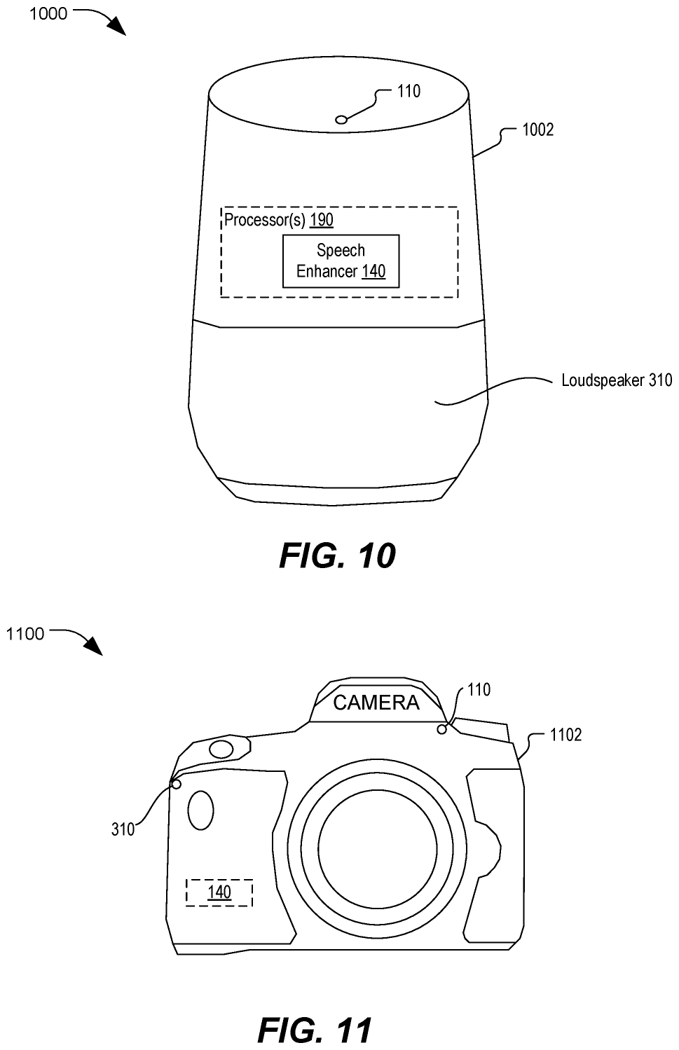

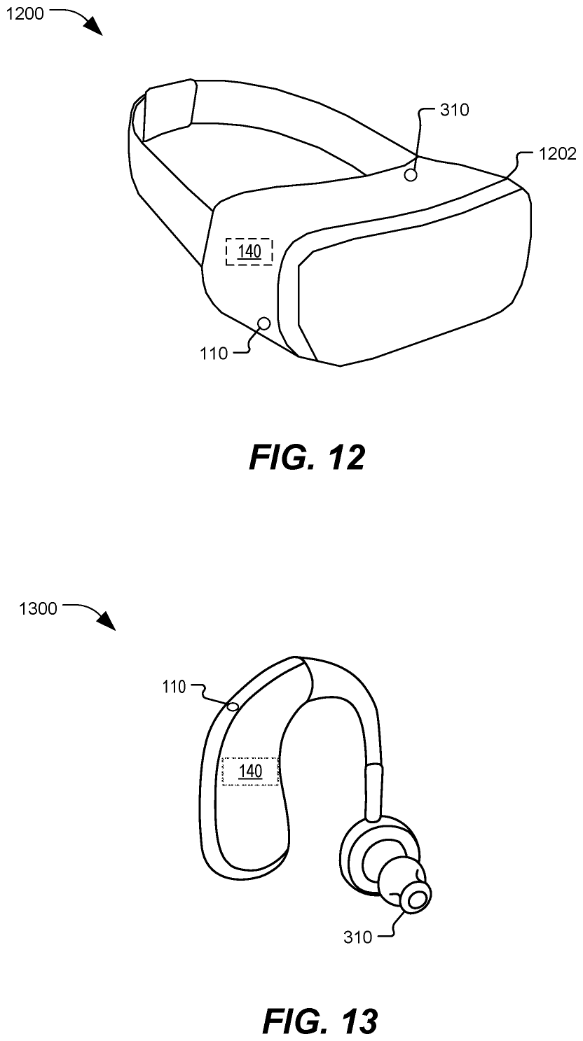

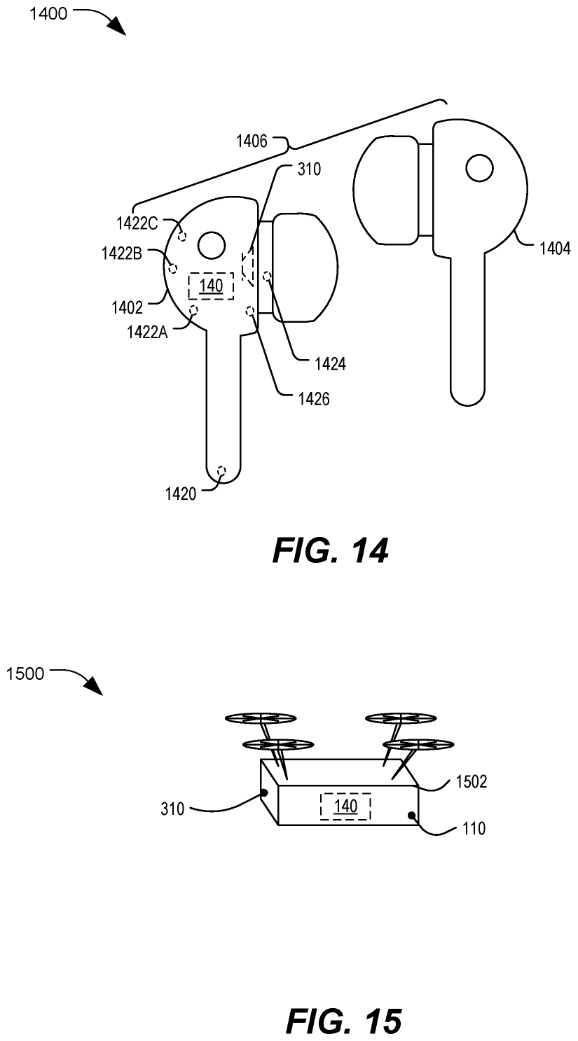

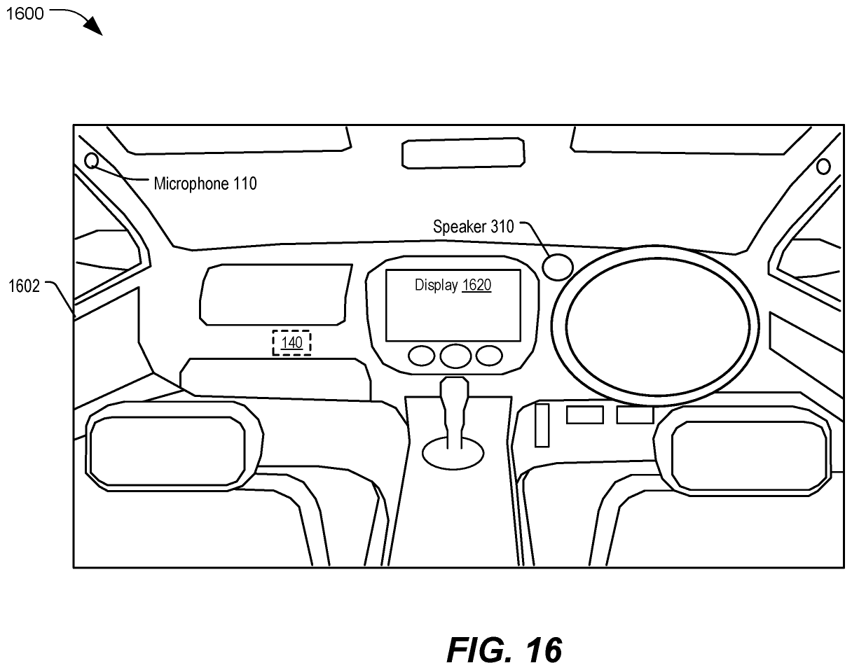

In some implementations, the device 102 corresponds to or is included in one of various types of devices. In an illustrative example, the one or more processors 190 are integrated in a headset device that includes the microphone 110, such as described further with reference to FIG. 8. In other examples, the one or more processors 190 are integrated in at least one of a mobile phone or a tablet computer device, as described with reference to FIG. 7, a wearable electronic device, as described with reference to FIG. 9, a voice-controlled speaker system, as described with reference to FIG. 10, a camera device, as described with reference to FIG. 11, a virtual reality, mixed reality, or augmented reality headset, as described with reference to FIG. 12, a hearing aid device, as described with reference to FIG. 13, or a pair of earbuds, as described with reference to FIG. 14. In another illustrative example, the one or more processors 190 are integrated into a vehicle that also includes the microphone 110, such as described further with reference to FIG. 15 and FIG. 16.

During operation, the speech enhancer 140 obtains an input audio signal 119 including at least speech 182 of a person 180. For example, the microphone 110 generates the microphone output signal 112 representing captured sounds, such as ambient sound 186 and the speech 182. As a non-limiting illustrative example, the ambient sound 186 can correspond to sounds from an open window, a wiper of a vehicle, a fan, a machine, an emergency vehicle, traffic, etc. In some aspects, the microphone output signal 112 can also include self-noise from the microphone 110.

In some implementations, the speech enhancer 140 provides the microphone output signal 112 as the input audio signal 119 to the trained model 120 and to the signal subtractor 124. In some other implementations in which the speech enhancer 140 includes the one or more filters 118, the one or more filters 118 process the microphone output signal 112 to generate the input audio signal 119, as further described with reference to FIG. 2 and FIG. 3. In some examples, the speech enhancer 140 selects a first filter from the one or more filters 118 based on an operation mode. The speech enhancer 140 processes the microphone output signal 112 using the first filter to generate the input audio signal 119, as further described with reference to FIG. 2. In an illustrative example, the operation mode indicates whether a window of a vehicle is open and the first filter is configured to remove wind noise. The one or more filters 118 provide the input audio signal 119 to the trained model 120 and to the signal subtractor 124.

In some examples, the one or more processors 190 obtain a second audio signal that is output via a loudspeaker. For example, the second audio signal can correspond to audio received by the device 102 during a call, music playback by the device 102, etc. Sound from the loudspeaker can be captured by the microphone 110 and represented in the microphone output signal 112. In some examples, the speech enhancer 140 uses a second filter of the one or more filters 118 to process the microphone output signal 112 based on the second audio signal to generate the input audio signal 119, as further described with reference to FIG. 3. To illustrate, the second filter is configured to remove sounds corresponding to the second audio signal. The one or more filters 118 provide the input audio signal 119 to the trained model 120 and to the signal subtractor 124. In this example, the speech enhancer 140 also provides the second audio signal to the trained model 120.

The speech enhancer 140 generates a predicted noise signal 123 based on processing of at least the input audio signal 119 by the trained model 120. For example, the speech enhancer 140 uses the trained model 120 to process the input audio signal 119 (and also the second audio signal in some implementations) to generate an intermediate predicted noise signal 121, as further described with reference to FIG. 4, and uses the adaptive filter 122 to process at least the intermediate predicted noise signal 121 to generate the predicted noise signal 123.

The signal subtractor 124 generates the output audio signal 125 based on a difference between the input audio signal 119 and the predicted noise signal 123. For example, the signal subtractor 124 subtracts the predicted noise signal 123 from the input audio signal 119 to generate the output audio signal 125.

The output audio signal 125 is provided to the adaptive filter 122 (e.g., a Wiener filter) as a feedback signal. For example, the trained model 120 generates a portion of the intermediate predicted noise signal 121 based on a portion of the input audio signal 119. The adaptive filter 122 generates a portion of the predicted noise signal 123 based on the portion of the intermediate predicted noise signal 121 and a previous portion of the output audio signal 125. The signal subtractor 124 subtracts the portion of the predicted noise signal 123 from the portion of the input audio signal 119 to generate a portion of the output audio signal 125 and provides the portion of the output audio signal 125 to the adaptive filter 122 to process a subsequent portion of the predicted noise signal 123. The speech enhancer 140 continues processing of the microphone output signal 112 to generate the output audio signal 125.

In a particular implementation, a transfer function of the adaptive filter 122 is controlled by variable parameters that are adjusted based on the output audio signal 125 according to an adjustment algorithm. For example, the adjustment algorithm determines the variable parameters (e.g., Wiener filter coefficients) based on speech and noise correlation to remove correlated audio in the predicted noise signal 123.

The system 100 thus enables generating the output audio signal 125 that retains a speech envelope of the input audio signal 119. In an example, the trained model 120 generates the intermediate predicted noise signal 121 such that the intermediate predicted noise signal 121 (and hence the predicted noise signal 123) includes less, if any, speech of the input audio signal 119. When the predicted noise signal 123 is subtracted from the input audio signal 119, more (e.g., all) of the speech envelope of the input audio signal 119 is retained in the output audio signal 125. A technical advantage of using the trained model 120 to generate the intermediate predicted noise signal 121 (e.g., instead of a predicted speech signal) can thus include improved accuracy of subsequent speech processing (e.g., by a speech recognition engine) of the output audio signal 125.

Although the microphone 110 is illustrated as external to the device 102, in other implementations the microphone 110 can be integrated in the device 102. Although the microphone output signal 112 is illustrated as received from a microphone 110 that is coupled to the device 102, in other implementations the speech enhancer 140 can obtain audio data representing the microphone output signal 112 of a microphone 110 coupled to or integrated in another device. Although the input audio signal 119 is illustrated as based on the microphone output signal 112 of the microphone 110, in other implementations the input audio signal 119 can be received from another device, generated by another component of the device 102, retrieved from a storage device, or a combination thereof.

Referring to FIG. 2, a particular illustrative aspect of a system 200 configured to perform speech enhancement using predicted noise is disclosed. In a particular aspect, the system 100 of FIG. 1 includes one or more components of the system 200.

The one or more filters 118 include a filter 118A that is configured to filter an audio signal 217 to generate a filtered audio signal 219. In some implementations, the filter 118A includes a linear filter (e.g., a FIR filter). The speech enhancer 140 has access to mode data 210 indicative of an operation mode 212. For example, the mode data 210 indicates an operation mode 212 of the device 102.

In a particular implementation, the mode data 210 indicates an operation mode 212 of a vehicle, an appliance, a machine, a window, a door, a building, or a combination thereof. In an example, the device 102 receives the mode data 210 from the vehicle, the appliance, the machine, a window sensor, a door sensor, a building management application, or a combination thereof. In an illustrative example, the operation mode 212 indicates whether a window is open, whether wipers of a vehicle are activated, whether an appliance is activated, or a combination thereof. To illustrate, the operation mode 212 can indicate environmental conditions around the microphone 110.

In a particular implementation, the mode data 210 can indicate a detected audio source of at least some of the ambient sound 186. To illustrate, the speech enhancer 140 uses audio recognition techniques to process the microphone output signal 112 to generate the mode data 210 having the operation mode 212 indicating that the microphone output signal 112 includes sounds from an emergency vehicle, an appliance, a fan, etc.

During operation, the speech enhancer 140 receives the microphone output signal 112 representing the speech 182 and the ambient sound 186. The ambient sound 186 includes sounds associated with the operation mode 212 indicated by the mode data 210. For example, the ambient sound 186 includes sounds of wind noise from an open window, sounds of moving wipers, sounds from a washing machine, etc.

The speech enhancer 140 selects the filter 118A from the one or more filters 118 based on the operation mode 212. In an example, the filter 118A is configured to remove sounds associated with the operation mode 212. The speech enhancer 140, in response to determining that the filter 118A is associated with the operation mode 212, selects the filter 118A from the one or more filters 118 and uses the filter 118A to process an audio signal 217 to generate a filtered audio signal 219. For example, the speech enhancer 140 uses the filter 118A to remove sounds (e.g., noise) associated with the operation mode 212 from the audio signal 217 to generate the filtered audio signal 219.

The audio signal 217 is based on the microphone output signal 112. In an example, the audio signal 217 includes the microphone output signal 112. In another example, the audio signal 217 includes a filtered audio signal generated by applying at least one of the one or more filters 118 to the microphone output signal 112. The input audio signal 119 is based on the filtered audio signal 219. In an example, the input audio signal 119 includes the filtered audio signal 219. In another example, the input audio signal 119 includes a filtered audio signal generated by applying at least one of the one or more filters 118 to the filtered audio signal 219.

Optionally, in some implementations, the speech enhancer 140 selects the trained model 120 based on the operation mode 212 indicated by the mode data 210. In some implementations, selecting the trained model 120 corresponds to selecting particular model parameters (e.g., weights, biases, or a combination thereof) corresponding to the operation mode 212, and configuring the trained model 120 based on the particular model parameters. In some implementations, selecting the trained model 120 corresponds to selecting the trained model 120 from a plurality of trained models (e.g., pre-configured models), where the trained model 120 is associated with the operation mode 212.

The trained model 120 (e.g., the selected model or the configured model) is trained to generate a predicted noise signal corresponding to audio (e.g., noise) associated with the operation mode 212. The speech enhancer 140 uses the trained model 120 to process the input audio signal 119 to generate the intermediate predicted noise signal 121, as further described with reference to FIG. 4.

The system 200 thus enables de-noising audio and predicting noise associated with the operation mode 212. A technical advantage of using the filter 118A, the trained model 120, or both, associated with the operation mode 212 includes improved speech envelope retention in the output audio signal 125.

Although the speech enhancer 140 is described as selecting both the filter 118A and the trained model 120 based on the operation mode 212, in some implementations the speech enhancer 140 can select one of the filter 118A or the trained model 120 based on the operation mode 212. Although the speech enhancer 140 is described as selecting both the filter 118A and the trained model 120 based on the same operation mode 212, in some implementations the speech enhancer 140 can select the filter 118A based on a first operation mode 212 indicated by the mode data 210 and select the trained model 120 based on a second operation mode 212 indicated by the mode data 210.

Referring to FIG. 3, a particular illustrative aspect of a system 300 operable to perform speech enhancement using predicted noise is disclosed. In a particular aspect, the system 100 of FIG. 1, the system 200 of FIG. 2, or both, include one or more components of the system 300.

The one or more processors 190 are configured to be coupled to a loudspeaker 310. The one or more processors 190 are configured to obtain an input audio signal 320 and provide the input audio signal 320 to the loudspeaker 310. Optionally, in some implementations, the device 102 is configured to receive the input audio signal 320 from a device 302.

The speech enhancer 140 is configured to provide the input audio signal 320 to the one or more filters 118, the trained model 120, or both. The one or more filters 118 include a filter 118B that is configured to filter an audio signal 317 based on the input audio signal 320 to generate a filtered audio signal 319. In some implementations, the filter 118B includes a linear filter (e.g., a FIR filter).

During operation, the speech enhancer 140 obtains an input audio signal 320 to output via the loudspeaker 310. In a particular aspect, the input audio signal 320 represents speech 382 of a person 380, ambient sound 386, or both. Optionally, in some implementations, the device 102 receives the input audio signal 320 from the device 302. In a particular aspect, the input audio signal 320 represents at least the speech 382, the ambient sound 386, or both, captured by a microphone 308 coupled to the device 302. In a particular aspect, the input audio signal 320 includes self-noise of the microphone 308.

In an illustrative example, the person 180 uses the device 102 to participate in a voice call (or a video conference) with the device 302 of the person 380. During the voice call, the device 102 plays out the input audio signal 320 (e.g., including the speech 382 of the person 380) via the loudspeaker 310. The microphone output signal 112 represents sound from the loudspeaker 310 (e.g., the speech 382, the ambient sound 386, and the self-noise of the microphone 308), the speech 182 from the person 180, the ambient sound 186, or a combination thereof, captured by the microphone 110. In a particular aspect, the microphone output signal 112 also includes self-noise of the microphone 110.

The speech enhancer 140 processes the microphone output signal 112 based on the input audio signal 320 to generate the output audio signal 125. In some implementations, the speech enhancer 140 selects the filter 118B from the one or more filters 118. For example, the speech enhancer 140, in response to determining that the filter 118B is associated with the person 380, the device 302, voice calls, or a combination thereof, selects the filter 118B from the one or more filters 118. The speech enhancer 140 uses the filter 118B to process an audio signal 317 and the input audio signal 320 to generate a filtered audio signal 319. For example, the speech enhancer 140 uses the filter 118B to remove sounds (e.g., the speech 382, the ambient sound 386, and the self-noise of the microphone 308) represented by the input audio signal 320 from the audio signal 317 to generate the filtered audio signal 319.

The audio signal 317 is based on the microphone output signal 112. In some examples, the audio signal 317 includes the microphone output signal 112. In other examples, the audio signal 317 includes a filtered audio signal generated by applying at least one (e.g., the filter 118A or another one) of the one or more filters 118 to the microphone output signal 112. The input audio signal 119 is based on the filtered audio signal 319. In some examples, the input audio signal 119 includes the filtered audio signal 319. In other examples, the input audio signal 119 includes a filtered audio signal generated by applying at least one (e.g., the filter 118A or another one) of the one or more filters 118 to the filtered audio signal 319.

In some implementations, the speech enhancer 140 uses the trained model 120 to process the input audio signal 119 and the input audio signal 320 to generate the intermediate predicted noise signal 121, as further described with reference to FIG. 4. For example, the trained model 120 is trained to generate, based on an audio signal (e.g., the input audio signal 320) provided to the loudspeaker 310, a predicted noise signal (e.g., the intermediate predicted noise signal 121) corresponding to noise included in the input audio signal 119. The adaptive filter 122 generates the predicted noise signal 123 based on the intermediate predicted noise signal 121, and the signal subtractor 124 subtracts the predicted noise signal 123 from the input audio signal 119 to generate the output audio signal 125, as described with reference to FIG. 1. In a particular aspect, the speech enhancer 140 sends the output audio signal 125 (e.g., including the speech 182 of the person 180) to the device 302.

The system 300 thus enables de-noising audio and predicting noise based on the input audio signal 320 that is output via the loudspeaker 310. A technical advantage of using the filter 118B, the trained model 120, or both, associated with the input audio signal 320 provided to the loudspeaker 310 includes improved speech envelope retention of the speech 182 in the output audio signal 125.

Although the speech enhancer 140 is described as using both the filter 118B and the trained model 120 to process the input audio signal 320, in some implementations the speech enhancer 140 can use one of the filter 118B or the trained model 120 to process the input audio signal 320. Although the speech enhancer 140 is illustrated as receiving the input audio signal 320 from the device 302, in other implementations the speech enhancer 140 can obtain the input audio signal 320 from another component of the device 102, a storage device, or both. Although the input audio signal 320 is described as audio received during a voice call, the input audio signal 320 can correspond to other types of audio such as music output via the loudspeaker 310.

Referring to FIG. 4, a particular illustrative aspect of the trained model 120 is disclosed. In a particular aspect, the trained model 120 is included in the system 100 of FIG. 1, the system 200 of FIG. 2, the system 300 of FIG. 3, or a combination thereof.

The trained model 120 includes a machine-learning model that is configured and trained to generate a predicted noise signal. In the example illustrated in FIG. 4, the trained model 120 includes a dimensional reduction network 420 coupled via one or more gated recurrent units (GRUs) 422 to a dimensional expansion network 424. The one or more GRUs 422 are used an illustrative example of one or more recurrent layers. In other implementations, the trained model 120 can include other types of recurrent layers as an alternative to or in addition to the one or more GRUs 422. Optionally, in some implementations, the dimensional expansion network 424 is coupled to a mask adjuster 426.

The dimensional reduction network 420 includes a plurality of layers (e.g., neural network layers) arranged to perform convolution, pooling, concatenation, and so forth, to generate an input latent-space representation 421 based on the input audio signal 119 and in some implementations also based on the input audio signal 320. In an example, the input audio signal 119 is input to the dimensional reduction network 420 as a series of input feature vectors, where each input feature vector of the series represents one or more audio data samples (e.g., a frame or another portion) of the input audio signal 119, and the dimensional reduction network 420 generates an input latent-space representation 421 associated with each input feature vector. The input feature vectors may include, for example, values representing spectral features of a time-windowed portion of the input audio signal 119 (e.g., a complex spectrum, a magnitude spectrum, a mel spectrum, a bark spectrum, etc.), cepstral features of a time-windowed portion of the input audio signal 119 (e.g., mel frequency cepstral coefficients, bark frequency cepstral coefficients, etc.), or other data representing a time-windowed portion of the input audio signal 119.

Similarly, in some implementations (as described with reference to FIG. 3), the input audio signal 320 is also input to the dimensional reduction network 420 as a series of input feature vectors, where each input feature vector of the series represents one or more audio data samples (e.g., a frame or another portion) of the input audio signal 320, and the dimensional reduction network 420 generates the input latent-space representation 421 also associated with each input feature vector of the input audio signal 320. The input feature vectors may include, for example, values representing spectral features of a time-windowed portion of the input audio signal 320 (e.g., a complex spectrum, a magnitude spectrum, a mel spectrum, a bark spectrum, etc.), cepstral features of a time-windowed portion of the input audio signal 320 (e.g., mel frequency cepstral coefficients, bark frequency cepstral coefficients, etc.), or other data representing a time-windowed portion of the input audio signal 320.

The one or more GRUs 422 are arranged to generate a predicted noise latent-space representation 423 based on the input latent-space representation 421. The dimensional expansion network 424 includes a plurality of layers (e.g., neural network layers) arranged to perform convolution, pooling, concatenation, and so forth, to generate a mask 425 based on the predicted noise latent-space representation 423.

Optionally, in some implementations, the trained model 120 may also include the mask adjuster 426 configured to adjust the mask 425 based on a criterion 427. The trained model 120 is configured to apply the mask 425 to the input audio signal 119 to generate the intermediate predicted noise signal 121.

During operation, the input audio signal 119 (or feature vectors representing the input audio signal 119) is provided as input to the trained model 120. The input audio signal 119 may represent the speech 182, the ambient sound 186, self-noise of the microphone 110, or a combination thereof. The speech 182 can include speech of a single person (e.g., the person 180) or speech of multiple persons. Optionally, in some implementations, the input audio signal 320 (or feature vectors representing the input audio signal 320) is also provided as input to the trained model 120. The input audio signal 320 may represent the speech 382, the ambient sound 386, self-noise of the microphone 308, or a combination thereof. The speech 382 can include speech of a single person (e.g., the person 380) or speech of multiple persons.

The dimensional reduction network 420 processes each feature vector of the input audio signal 119 through a sequence of convolution operations, pooling operations, activation layers, other data manipulation operations, or any combination thereof, based on the architecture and training of the dimensional reduction network 420, to generate an input latent-space representation 421 of the feature vectors of the input audio signal 119. Similarly, in some implementations, the dimensional reduction network 420 also processes each feature vector of the input audio signal 320 through a sequence of convolution operations, pooling operations, activation layers, other data manipulation operations, or any combination thereof, based on the architecture and training of the dimensional reduction network 420, to generate at least a portion of the input latent-space representation 421 representing the feature vectors of the input audio signal 320.

The one or more GRUs 422 generate the predicted noise latent-space representation 423 based on the input latent-space representation 421. For example, the one or more GRUs 422 can be thought of as a generative network that is configured and trained to predict noise in an input audio data stream (e.g., the input audio signal 119). In some implementations, sounds similar to those (e.g., the speech 382, the ambient sound 386, the self-noise of the microphone 308, or a combination thereof) represented in the input audio signal 320 are also considered noise in the input audio signal 119. The dimensional expansion network 424 generates the mask 425 based on the predicted noise latent-space representation 423. For example, the dimensional expansion network 424 generates the mask 425 that can be used to extract sounds corresponding to the predicted noise indicated by the predicted noise latent-space representation 423.

Optionally, in some implementations, the mask adjuster 426 selectively adjusts the mask 425 based on a criterion 427. In an example, the criterion 427 is based on determining whether the output audio signal 125 is to be used for a voice call or ASR (e.g., keyword detection, user verification, speech recognition, speaker recognition, etc.). In some examples, the mask adjuster 426, in response to determining that the output audio signal 125 is to be used for a voice call, adjusts weights of the mask 425 to increase the aggressiveness of the mask 425 in extracting sounds corresponding to the predicted noise so there is less (e.g., no) noise leakage in the output audio signal 125. Alternatively, in some examples, the mask 425, in response to determining that the output audio signal 125 is to be used for ASR, adjusts weights of the mask 425 to decrease aggressiveness of the mask 425 in extracting sounds corresponding to the predicted noise to ensure that more of the speech envelope is preserved in the output audio signal 125 even if there is some noise leakage.

The trained model 120 uses the mask 425 to process the input audio signal 119. For example, the trained model 120 applies the mask 425 to the input audio signal 119 to generate the intermediate predicted noise signal 121. To illustrate, applying the mask 425 to the input audio signal 119 extracts sounds corresponding to the predicted noise from the input audio signal 119 to generate the intermediate predicted noise signal 121.

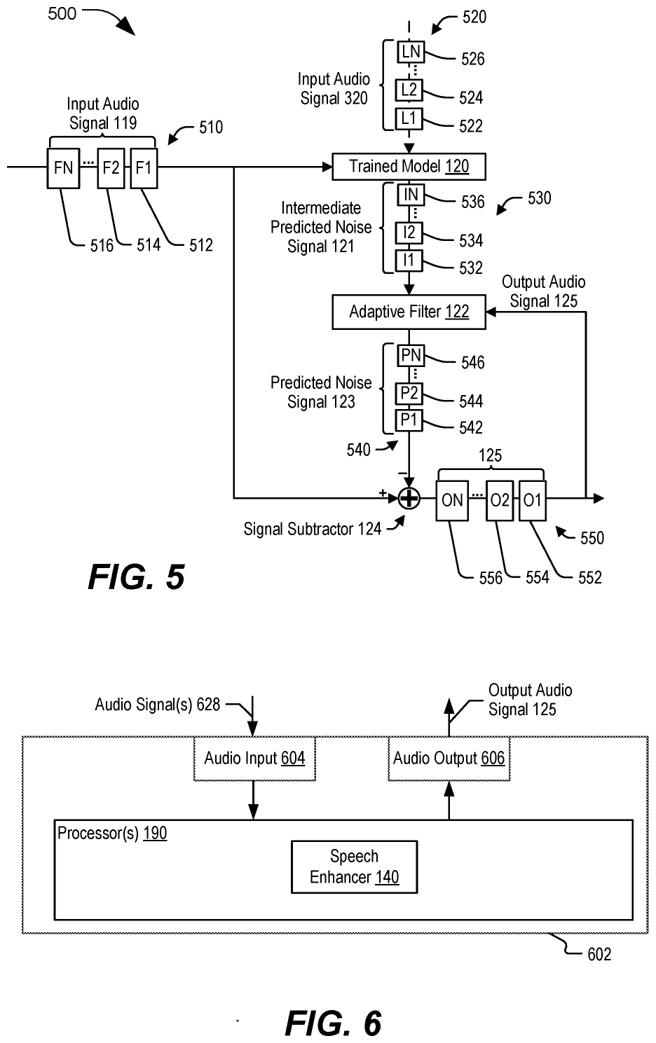

FIG. 5 is a diagram of an illustrative aspect of operation of components of the system 100 of FIG. 1, the system 200 of FIG. 2, the system 300 of FIG. 3, or a combination thereof. The trained model 120 is configured to receive a sequence 510 of audio data samples, such as a sequence of successively captured frames of the input audio signal 119, illustrated as a first frame (F1) 512, a second frame (F2) 514, and one or more additional frames including an Nth frame (FN) 516 (where N is an integer greater than two). Optionally, in some implementations, the trained model 120 is also configured to receive a sequence 520 of sets of audio data, such as a sequence of frames of the input audio signal 320 that are to be successively output via the loudspeaker 310, illustrated as a first frame (L1) 522, a second frame (L2) 524, one or more additional frames including an Nth frame (LN) 526 (where Nis an integer greater than two). In some implementations, a second count of frames in the sequence 520 is different from a first count of frames in the sequence 510.

The trained model 120 is configured to output a sequence 530 of sets of audio data, such as a sequence of frames of the intermediate predicted noise signal 121, illustrated as a first frame (I1) 532, a second frame (I2) 534, one or more additional frames including an Nth frame (IN) 536 (where N is an integer greater than two). In some implementations, a third count of frames in the sequence 530 is different from the first count of frames in the sequence 510, the second count of frames in the sequence 520, or both.

The adaptive filter 122 is configured to receive the sequence 530 and to output a sequence 540 of sets of audio data, such as a sequence of frames of the predicted noise signal 123, illustrated as a first frame (P1) 542, a second frame (P2) 544, one or more additional frames including an Nth frame (PN) 546 (where Nis an integer greater than two). In some implementations, a fourth count of frames in the sequence 540 is different from the first count of frames in the sequence 510, the second count of frames in the sequence 520, the third count of frames in the sequence 530, or a combination thereof.

The signal subtractor 124 is configured to subtract the sequence 540 from the sequence 510 to generate a sequence 550 of sets of audio data, such as a sequence of frames of the output audio signal 125, illustrated as a first frame (01) 552, a second frame (02) 554, one or more additional frames including an Nth frame (ON) 556 (where N is an integer greater than two). In some implementations, a fifth count of frames in the sequence 550 is different from the first count of frames in the sequence 510, the second count of frames in the sequence 520, the third count of frames in the sequence 530, the fourth count of frames in the sequence 540, or a combination thereof.

During operation, the trained model 120 processes the first frame (F1) 512 of the input audio signal 119, and in some implementations the first frame (L1) 522 of the input audio signal 320, to generate the first frame (I1) 532 of the intermediate predicted noise signal 121, and the adaptive filter 122 processes the first frame (I1) 532 of the intermediate predicted noise signal 121 to generate the first frame (P1) 542 of the predicted noise signal 123. The signal subtractor 124 subtracts the first frame (P1) 542 of the predicted noise signal 123 from the first frame (F1) 512 of the input audio signal 119 to generate the first frame (01) 552 of the output audio signal 125.

The trained model 120 processes the second frame (F2) 514 of the input audio signal 119, and in some implementations the second frame (L2) 524 of the input audio signal 320, to generate the second frame (I2) 534 of the intermediate predicted noise signal 121, and the adaptive filter 122 processes the second frame (I2) 534 of the intermediate predicted noise signal 121 and the first frame (01) 552 of the output audio signal 125 to generate the second frame (P2) 544 of the predicted noise signal 123. The signal subtractor 124 subtracts the second frame (P2) 544 of the predicted noise signal 123 from the second frame (F2) 514 of the input audio signal 119 to generate the second frame (02) 554 of the output audio signal 125.

Such processing continues, including the trained model 120 processing the Nth frame (FN) 516 of the input audio signal 119, and in some implementations the Nth frame (LN) 526 of the input audio signal 320, to generate the Nth frame (IN) 536 of the intermediate predicted noise signal 121, and the adaptive filter 122 processing the Nth frame (IN) 536 of the intermediate predicted noise signal 121 and one or more previous frames of the output audio signal 125 to generate the Nth frame (PN) 546 of the predicted noise signal 123. The signal subtractor 124 subtracts the Nth frame (PN) 546 of the predicted noise signal 123 from the Nth frame (FN) 516 of the input audio signal 119 to generate the Nth frame (ON) 556 of the output audio signal 125.

By subtracting the predicted noise signal 123 from the input audio signal 119, more of the speech envelope of the input audio signal 119 is preserved in the output audio signal 125 to improve accuracy of ASR performed on the output audio signal 125.

FIG. 6 depicts an implementation 600 of the device 102 as an integrated circuit 602 that includes the one or more processors 190. The integrated circuit 602 also includes an audio input 604, such as one or more bus interfaces, to enable one or more audio signals 628 to be received for processing. In some aspects, the one or more audio signals 628 include the microphone output signal 112, the input audio signal 119 of FIG. 1, the input audio signal 320 of FIG. 3, or a combination thereof. The integrated circuit 602 also includes an audio output 606, such as a bus interface, to enable sending of an output signal, such as the output audio signal 125. The integrated circuit 602 enables implementation of perform speech enhancement using predicted noise as a component in a system that includes microphones, such as a mobile phone or tablet as depicted in FIG. 7, a headset as depicted in FIG. 8, a wearable electronic device as depicted in FIG. 9, a voice-controlled speaker system as depicted in FIG. 10, a camera as depicted in FIG. 11, a virtual reality, mixed reality, or augmented reality headset as depicted in FIG. 12, a hearing aid device as depicted in FIG. 13, earbuds as depicted in FIG. 14, or a vehicle as depicted in FIG. 15 or FIG. 16.

FIG. 7 depicts an implementation 700 in which the device 102 includes a mobile device 702, such as a phone or tablet, as illustrative, non-limiting examples. The mobile device 702 includes the microphone 110, the loudspeaker 310, and a display screen 704. Components of the one or more processors 190, including the speech enhancer 140, are integrated in the mobile device 702 and are illustrated using dashed lines to indicate internal components that are not generally visible to a user of the mobile device 702. In a particular example, the speech enhancer 140 operates to generate the output audio signal 125 that is processed (e.g., using ASR techniques) to detect user voice activity in the output audio signal 125, which may cause the mobile device 702 to perform one or more operations at the mobile device 702, such as to launch a graphical user interface or otherwise display other information associated with the user's speech at the display screen 704 (e.g., via an integrated “smart assistant” application).

FIG. 8 depicts an implementation 800 in which the device 102 includes a headset device 802. The headset device 802 includes the microphone 110 and the loudspeaker 310. Components of the one or more processors 190, including the speech enhancer 140, are integrated in the headset device 802. In a particular example, the speech enhancer 140 operates to generate the output audio signal 125 that is processed (e.g., using ASR techniques) to detect user voice activity, which may cause the headset device 802 to perform one or more operations at the headset device 802, to transmit audio data corresponding to the user voice activity to a second device (not shown) for further processing.

FIG. 9 depicts an implementation 900 in which the device 102 includes a wearable electronic device 902, illustrated as a “smart watch.” The speech enhancer 140, the microphone 110, and the loudspeaker 310 are integrated into the wearable electronic device 902. In a particular example, the speech enhancer 140 operates generate the output audio signal 125 that is processed (e.g., using ASR techniques) to detect user voice activity, which may cause the wearable electronic device 902 to perform one or more operations at the wearable electronic device 902, such as to launch a graphical user interface or otherwise display other information associated with the user's speech at a display screen 904 of the wearable electronic device 902. To illustrate, the wearable electronic device 902 may include a display screen that is configured to display a notification based on user speech detected by the wearable electronic device 902. In a particular example, the wearable electronic device 902 includes a haptic device that provides a haptic notification (e.g., vibrates) in response to detection of user voice activity. For example, the haptic notification can cause a user to look at the wearable electronic device 902 to see a displayed notification indicating detection of a keyword spoken by the user. The wearable electronic device 902 can thus alert a user with a hearing impairment or a user wearing a headset that the user's voice activity is detected.

FIG. 10 is an implementation 1000 in which the device 102 includes a wireless speaker and voice activated device 1002. The wireless speaker and voice activated device 1002 can have wireless network connectivity and is configured to execute an assistant operation. The one or more processors 190 including the speech enhancer 140, the microphone 110, the loudspeaker 310, or a combination thereof, are included in the wireless speaker and voice activated device 1002. During operation, the speech enhancer 140 generates the output audio signal 125 and in response to receiving a verbal command identified as user speech via performing ASR on the output audio signal 125, the wireless speaker and voice activated device 1002 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”).

FIG. 11 depicts an implementation 1100 in which the device 102 includes a portable electronic device that corresponds to a camera device 1102. The speech enhancer 140, the microphone 110, the loudspeaker 310, or a combination thereof, are included in the camera device 1102. During operation, the speech enhancer 140 generates the output audio signal 125 and in response to receiving a verbal command identified as user speech via performing ASR on the output audio signal 125, the camera device 1102 can execute operations responsive to spoken user commands, such as to adjust image or video capture settings, image or video playback settings, or image or video capture instructions, as illustrative examples.

FIG. 12 depicts an implementation 1200 in which the device 102 includes a portable electronic device that corresponds to a virtual reality, mixed reality, or augmented reality headset 1202. The speech enhancer 140, the microphone 110, the loudspeaker 310, or a combination thereof, are integrated into the headset 1202. The speech enhancer 140 can process the microphone output signal 112 received from the microphone 110 of the headset 1202 to generate the output audio signal 125. User voice activity detection can be performed on the output audio signal 125. A visual interface device is positioned in front of the user's eyes to enable display of augmented reality, mixed reality, or virtual reality images or scenes to the user while the headset 1202 is worn. In a particular example, the visual interface device is configured to display a notification indicating user speech detected in the output audio signal 125.

FIG. 13 illustrates a hearing aid device 1300 that incorporates aspects of the device 102 of FIG. 1, FIG. 2, FIG. 3, or a combination thereof. The hearing aid device 1300 includes the microphone 110, the loudspeaker 310, the speech enhancer 140, or a combination thereof. During operation, the hearing aid device 1300 may process the microphone output signal 112 received from the microphone 110 to generate the output audio signal 125 for the user of the hearing aid device 1300.

FIG. 14 depicts an implementation 1400 in which the device 102 includes a portable electronic device that corresponds to a pair of earbuds 1406 that includes a first earbud 1402 and a second earbud 1404. Although earbuds are described, it should be understood that the present technology can be applied to other in-ear or over-ear playback devices.

The first earbud 1402 includes a first microphone 1420, such as a high signal-to-noise microphone positioned to capture the voice of a wearer of the first earbud 1402, an array of one or more other microphones configured to detect ambient sounds and spatially distributed to support beamforming, illustrated as microphones 1422A, 1422B, and 1422C, an “inner” microphone 1424 proximate to the wearer's ear canal (e.g., to assist with active noise cancelling), and a self-speech microphone 1426, such as a bone conduction microphone configured to convert sound vibrations of the wearer's ear bone or skull into an audio signal.

In a particular implementation, one or more of the microphones 1420, 1422A, 1422B, 1422C, 1424, or 1426 correspond to instances of the microphone 110, and audio signals generated by one or more of the microphones 1420, 1422A, 1422B, 1422C, 1424, or 1426 are provided to the speech enhancer 140. The speech enhancer 140 may function to generate the output audio signal 125 based on the audio signals, ASR may be performed on the output audio signal 125 to detect user voice activity, and the first earbud 1402 may perform one or more operations based on the user voice activity.

The second earbud 1404 can be configured in a substantially similar manner as the first earbud 1402. In some implementations, the speech enhancer 140 of the first earbud 1402 is also configured to receive one or more audio signals generated by one or more microphones of the second earbud 1404, such as via wireless transmission between the earbuds 1402, 1404, or via wired transmission in implementations in which the earbuds 1402, 1404 are coupled via a transmission line. In other implementations, the second earbud 1404 also includes a speech enhancer 140, enabling techniques described herein to be performed by a user wearing a single one of either of the earbuds 1402, 1404.

In some implementations, the earbuds 1402, 1404 are configured to automatically switch between various operating modes, such as a passthrough mode in which ambient sound is played via a loudspeaker 310, a playback mode in which non-ambient sound (e.g., streaming audio corresponding to a phone conversation, media playback, video game, etc.) is played back through the loudspeaker 310, and an audio zoom mode or beamforming mode in which one or more ambient sounds are emphasized and/or other ambient sounds are suppressed for playback at the loudspeaker 310. In other implementations, the earbuds 1402, 1404 may support fewer modes or may support one or more other modes in place of, or in addition to, the described modes.

In an illustrative example, the earbuds 1402, 1404 can automatically transition from the playback mode to the passthrough mode in response to detecting the wearer's voice, and may automatically transition back to the playback mode after the wearer has ceased speaking. In some examples, the earbuds 1402, 1404 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

FIG. 15 depicts an implementation 1500 in which the device 102 corresponds to, or is integrated within, a vehicle 1502, illustrated as a manned or unmanned aerial device (e.g., a package delivery drone). The speech enhancer 140, the microphone 110, the loudspeaker 310, or a combination thereof, are integrated into the vehicle 1502. The speech enhancer 140 can generate the output audio signal 125 based on the microphone output signal 112 received from the microphone 110, the input audio signal 320 output via the loudspeaker 310, or both. User voice activity detection can be performed (e.g., using ASR techniques) on the output audio signal 125, such as for delivery instructions from an authorized user of the vehicle 1502.

FIG. 16 depicts another implementation 1600 in which the device 102 corresponds to, or is integrated within, a vehicle 1602, illustrated as a car. The vehicle 1602 includes the one or more processors 190 including the speech enhancer 140. The vehicle 1602 also includes the microphone 110 and the loudspeaker 310. The speech enhancer 140 can generate the output audio signal 125 based on the microphone output signal 112 received from the microphone 110, the input audio signal 320 output via the loudspeaker 310, or both. User voice activity detection can be performed (e.g., using ASR techniques) on the output audio signal 125. In some implementations, user voice activity detection can be performed based on an audio signal received from interior microphones (e.g., the microphone 110), such as for a voice command from an authorized passenger. For example, the user voice activity detection can be used to detect a voice command from an operator of the vehicle 1602 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the microphone 110), such as an authorized user of the vehicle. In a particular implementation, in response to receiving a verbal command identified as user speech via operation of the speech enhancer 140 and ASR techniques, a voice activation system initiates one or more operations of the vehicle 1602 based on one or more keywords (e.g., “unlock,” “start engine,” “play music,” “display weather forecast,” or another voice command) detected in the output audio signal 125, such as by providing feedback or information via a display 1620 or one or more speakers (e.g., the loudspeaker 310).

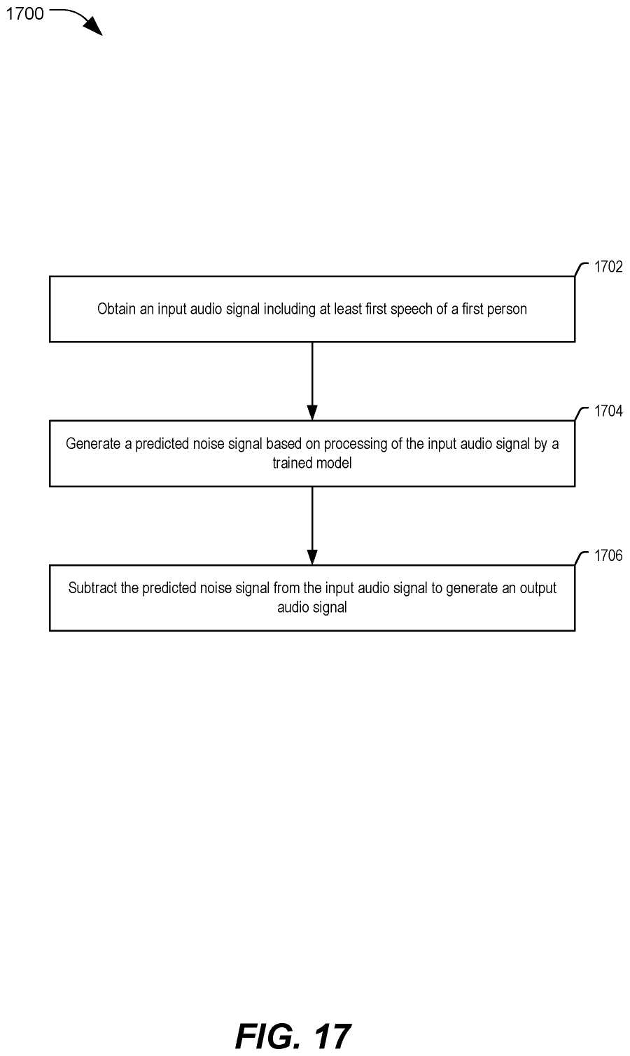

Referring to FIG. 17, a particular implementation of a method 1700 of performing speech enhancement using predicted noise is shown. In a particular aspect, one or more operations of the method 1700 are performed by at least one of the one or more filters 118, the speech enhancer 140, the trained model 120, the adaptive filter 122, the signal subtractor 124, the one or more processors 190, the device 102, the system 100 of FIG. 1, the system 200 of FIG. 2, the system 300 of FIG. 3, the dimensional reduction network 420, the one or more GRUs 422, the dimensional expansion network 424, the mask adjuster 426, or a combination thereof.

The method 1700 includes obtaining an input audio signal including at least first speech of a first person, at 1702. For example, the speech enhancer 140 obtains the input audio signal 119 including at least the speech 182 of the person 180, as described with reference to FIGS. 1-3.

The method 1700 also includes generating a predicted noise signal based on processing of the input audio signal by a trained model, at 1704. For example, the speech enhancer 140 generates the predicted noise signal 123 based on processing of the input audio signal 119 by the trained model 120, as described with reference to FIGS. 1 and 3.

The method 1700 further includes subtracting the predicted noise signal from the input audio signal to generate an output audio signal, at 1706. For example, the speech enhancer 140 subtracts the predicted noise signal 123 from the input audio signal 119 to generate the output audio signal 125, as described with reference to FIG. 1.

The method 1700 enables generating the output audio signal 125 by removing the predicted noise signal 123 from the input audio signal 119 to retain more of a speech envelope of the input audio signal 119 in the output audio signal 125. For example, the trained model 120 generates the intermediate predicted noise signal 121 such that the intermediate predicted noise signal 121 does not include any speech of the input audio signal 119 and hence the predicted noise signal 123 does not include any speech of the input audio signal 119. When the predicted noise signal 123 is subtracted from the input audio signal 119, the speech envelope of the input audio signal 119 is retained in the output audio signal 125. A technical advantage of using the trained model 120 to generate the intermediate predicted noise signal 121 (e.g., instead of a predicted speech signal) can thus include improved accuracy of subsequent speech processing (e.g., by an automatic speech recognition engine) of the output audio signal 125 that retains the speech envelope of the input audio signal 119.

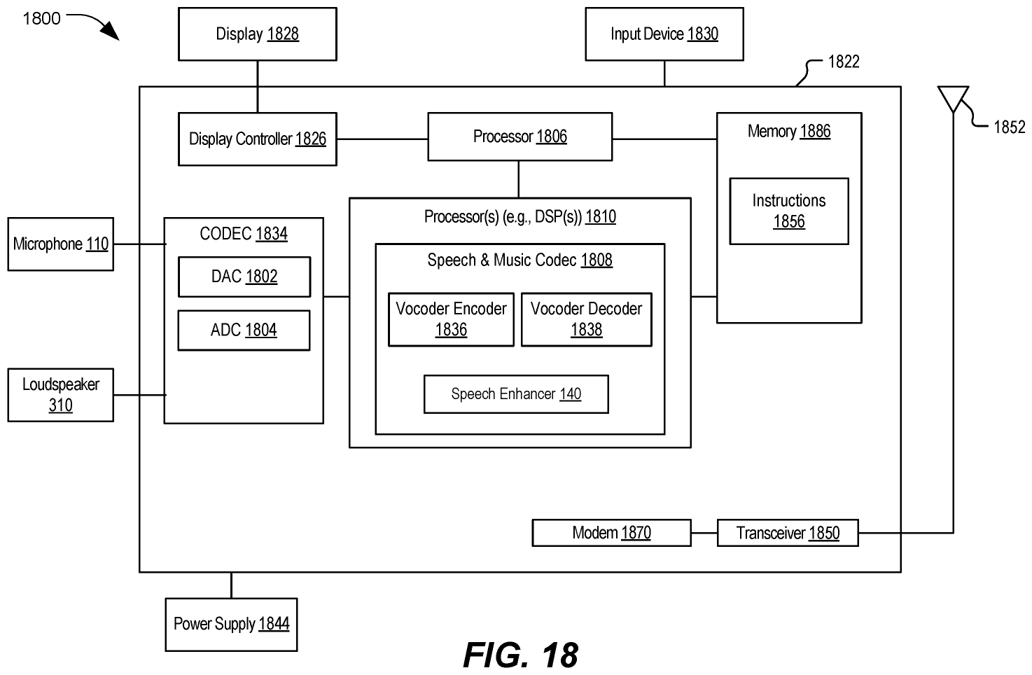

The method 1700 of FIG. 17 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102. In an illustrative implementation, the device 1800 may perform one or more operations described with reference to FIGS. 1-17.

In a particular implementation, the device 1800 includes a processor 1806 (e.g., a CPU). The device 1800 may include one or more additional processors 1810 (e.g., one or more DSPs). In a particular aspect, the one or more processors 190 of FIG. 1 correspond to the processor 1806, the processors 1810, or a combination thereof. The processors 1810 may include a speech and music coder-decoder (CODEC) 1808 that includes a voice coder (“vocoder”) encoder 1836, a vocoder decoder 1838, the speech enhancer 140, or a combination thereof.

The device 1800 may include a memory 1886 and a CODEC 1834. The memory 1886 may include instructions 1856, that are executable by the one or more additional processors 1810 (or the processor 1806) to implement the functionality described with reference to the speech enhancer 140. The device 1800 may include a modem 1870 coupled, via a transceiver 1850, to an antenna 1852.

The device 1800 may include a display 1828 coupled to a display controller 1826. The loudspeaker 310 and the microphone 110 may be coupled to the CODEC 1834. The CODEC 1834 may include a digital-to-analog converter (DAC) 1802, an analog-to-digital converter (ADC) 1804, or both. In a particular implementation, the CODEC 1834 may receive an analog signal from the microphone 110, convert the analog signal to a digital signal using the analog-to-digital converter 1804, and provide the digital signal to the speech and music codec 1808. The speech and music codec 1808 may process the digital signal, and the digital signal may further be processed (e.g., as the microphone output signal 112) by the speech enhancer 140. In a particular implementation, the speech and music codec 1808 may provide a digital signal (e.g., the output audio signal 125) to the CODEC 1834. The CODEC 1834 may convert the digital signal to an analog signal using the digital-to-analog converter 1802 and may provide the analog signal to the loudspeaker 310.

In a particular implementation, the device 1800 may be included in a system-in-package or system-on-chip device 1822. In a particular implementation, the memory 1886, the processor 1806, the processors 1810, the display controller 1826, the CODEC 1834, and the modem 1870 are included in the system-in-package or system-on-chip device 1822. In a particular implementation, an input device 1830 and a power supply 1844 are coupled to the system-in-package or the system-on-chip device 1822.

Moreover, in a particular implementation, as illustrated in FIG. 18, the display 1828, the input device 1830, the loudspeaker 310, the microphone 110, the antenna 1852, and the power supply 1844 are external to the system-in-package or the system-on-chip device 1822. In a particular implementation, each of the display 1828, the input device 1830, the loudspeaker 310, the microphone 110, the antenna 1852, and the power supply 1844 may be coupled to a component of the system-in-package or the system-on-chip device 1822, such as an interface or a controller.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining an input audio signal including at least first speech of a first person. For example, the means for obtaining can correspond to the microphone 110, the one or more filters 118, the speech enhancer 140, the one or more processors 190, the device 102, the system 100 of FIG. 1, the system 200 of FIG. 2, the system 300 of FIG. 3, the processor 1806, the processors 1810, the device 1800, the modem 1870, the transceiver 1850, the antenna 1852, one or more other circuits or components configured to obtain the input audio signal, or any combination thereof.

The apparatus also includes means for generating a predicted noise signal based on processing of the input audio signal by a trained model. For example, the means for generating can correspond to the trained model 120, the adaptive filter 122, the speech enhancer 140, the one or more processors 190, the device 102, the system 100 of FIG. 1, the system 200 of FIG. 2, the system 300 of FIG. 3, the dimensional reduction network 420, the one or more GRUs 422, the dimensional expansion network 424, the mask adjuster 426 of FIG. 4, the processor 1806, the processors 1810, the device 1800, one or more other circuits or components configured to generate the predicted noise signal, or a combination thereof.

The apparatus further includes means for subtracting the predicted noise signal from the input audio signal to generate an output audio signal. For example, the means for subtracting can correspond to the signal subtractor 124, the speech enhancer 140, the one or more processors 190, the device 102, the system 100 of FIG. 1, the system 200 of FIG. 2, the system 300 of FIG. 3, the processor 1806, the processors 1810, the device 1800, one or more other circuits or components configured to subtract the predicted noise signal from the input audio signal, or a combination thereof.

In some implementations, a non-transitory computer-readable medium (e.g., a computer-readable storage device, such as the memory 1886) stores instructions (e.g., the instructions 1856) that, when executed by one or more processors (e.g., the one or more processors 1810 or the processor 1806), cause the one or more processors to obtain an input audio signal (e.g., the input audio signal 119) including at least first speech (e.g., the speech 182) of a first person (e.g., the person 180). The instructions, when executed by the one or more processors, also cause the one or more processors to generate a predicted noise signal (e.g., the predicted noise signal 123) based on processing of the input audio signal by a trained model (e.g., the trained model 120). The instructions, when executed by the one or more processors, further cause the one or more processors to subtract the predicted noise signal from the input audio signal to generate an output audio signal (e.g., the output audio signal 125).

Particular aspects of the disclosure are described below in sets of interrelated Examples:

According to Example 1, a device includes one or more processors configured to obtain an input audio signal including at least first speech of a first person; generate a predicted noise signal based on processing of the input audio signal by a trained model; and subtract the predicted noise signal from the input audio signal to generate an output audio signal.

Example 2 includes the device of Example 1, wherein, to generate the predicted noise signal, the one or more processors are configured to process, using the trained model, the input audio signal to generate an intermediate predicted noise signal; and process, using an adaptive filter, the intermediate predicted noise signal to generate the predicted noise signal.

Example 3 includes the device of Example 1 or Example 2, wherein the adaptive filter includes a non-linear filter.

Example 4 includes the device of Example 3, wherein the non-linear filter includes a Wiener filter.

Example 5 includes the device of any of Examples 1 to 4, wherein the trained model includes a neural network.

Example 6 includes the device of any of Examples 1 to 5, wherein the one or more processors are further configured to receive a microphone output signal from a microphone, and wherein the input audio signal is based on the microphone output signal.

Example 7 includes the device of Example 6, wherein the one or more processors are configured to process, using one or more filters, the microphone output signal to generate the input audio signal.

Example 8 includes the device of Example 7, wherein the one or more filters include a linear filter.

Example 9 includes the device of Example 8, wherein the linear filter includes a finite impulse response (FIR) filter.

Example 10 includes the device of any of Examples 7 to 9, wherein the one or more processors are configured to obtain mode data indicative of an operation mode; and select a filter based on the operation mode, wherein the one or more filters include the filter.

Example 11 includes the device of Example 10, wherein the operation mode indicates whether a window is open, whether wipers of a vehicle are activated, or both.

Example 12 includes the device of any of Examples 1 to 11, wherein the one or more processors are configured to obtain a second input audio signal including at least second speech of a second person, wherein the output audio signal is based at least in part on the second input audio signal.

Example 13 includes the device of Example 12, wherein the one or more processors are configured to receive a microphone output signal from a microphone, and wherein the microphone output signal and the second input audio signal are processed using one or more filters to generate the input audio signal.

Example 14 includes the device of Example 12 or Example 13, wherein the input audio signal and the second input audio signal are processed using the trained model to generate the predicted noise signal.

Example 15 includes the device of any of Examples 12 to 14, wherein the second input audio signal is received from a second device.

Example 16 includes the device of any of Examples 1 to 15, wherein the one or more processors are further configured to obtain mode data indicative of an operation mode; and select, based on the operation mode, the trained model from a plurality of trained models to process the input audio signal.

Example 17 includes the device of any of Examples 1 to 16, wherein the one or more processors are further configured to selectively adjust weights of a time-frequency mask based on a criterion, and wherein the one or more processors are configured to process the input audio signal using the trained model by applying the time-frequency mask to the input audio signal to generate the predicted noise signal.

Example 18 includes the device of Example 17, wherein the criterion is based on determining whether the output audio signal is to be used for automated speech recognition.

According to Example 19, a method includes obtaining, at a device, an input audio signal including at least first speech of a first person; generating, at the device, a predicted noise signal based on processing of the input audio signal by a trained model; and subtracting, at the device, the predicted noise signal from the input audio signal to generate an output audio signal.

Example 20 includes the method of Example 19, wherein generating the predicted noise signal includes: processing, using the trained model, the input audio signal to generate an intermediate predicted noise signal; and processing, using an adaptive filter, the intermediate predicted noise signal to generate the predicted noise signal.

Example 21 includes the method of Example 19 or Example 20, wherein the adaptive filter includes a non-linear filter.

Example 22 includes the method of Example 21, wherein the non-linear filter includes a Wiener filter.

Example 23 includes the method of any of Examples 19 to 22, wherein the trained model includes a neural network.

Example 24 includes the method of any of Examples 19 to 23 and further includes receiving a microphone output signal from a microphone, wherein the input audio signal is based on the microphone output signal.

Example 25 includes the method of Example 24 and further includes processing, using one or more filters, the microphone output signal to generate the input audio signal.

Example 26 includes the method of Example 25, wherein the one or more filters include a linear filter.

Example 27 includes the method of Example 26, wherein the linear filter includes a finite impulse response (FIR) filter.

Example 28 includes the method of any of Examples 25 to 27, further includes obtaining, at the device, mode data indicative of an operation mode; and selecting, at the device, a filter based on the operation mode, wherein the one or more filters include the filter.

According to Example 29, a device includes: a memory configured to store instructions; and a processor configured to execute the instructions to perform the method of any of Example 19 to 28.

According to Example 30, a non-transitory computer-readable medium stores instructions that, when executed by a processor, cause the processor to perform the method of any of Example 19 to Example 28.

According to Example 31, an apparatus includes means for carrying out the method of any of Example 19 to Example 28.

According to Example 32, a non-transitory computer-readable medium storing instructions that, when executed by one or more processors, cause the one or more processors to obtain an input audio signal including at least first speech of a first person; generate a predicted noise signal based on processing of the input audio signal by a trained model; and subtract the predicted noise signal from the input audio signal to generate an output audio signal.

Example 33 includes the non-transitory computer-readable medium of Example 32, wherein the instructions, when executed by the one or more processors, further cause the one or more processors to obtain a second input audio signal including at least second speech of a second person, wherein the output audio signal is based at least in part on the second input audio signal.

According to Example 34, an apparatus includes means for obtaining an input audio signal including at least first speech of a first person; means for generating a predicted noise signal based on processing of the input audio signal by a trained model; and means for subtracting the predicted noise signal from the input audio signal to generate an output audio signal.

Example 35 includes the apparatus of Example 34, wherein the means for obtaining, the means for generating, and the means for subtracting are integrated into at least one of a smart speaker, a speaker bar, a smart phone, a computer, a display device, a television, a gaming console, a music player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a mobile device, or any combination thereof.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain an input audio signal including at least first speech of a first person;
generate a predicted noise signal based on processing of the input audio signal by a trained model; and
subtract the predicted noise signal from the input audio signal to generate an output audio signal.

2. The device of claim 1, wherein, to generate the predicted noise signal, the one or more processors are configured to:
process, using the trained model, the input audio signal to generate an intermediate predicted noise signal; and
process, using an adaptive filter, the intermediate predicted noise signal to generate the predicted noise signal.

3. The device of claim 2, wherein the adaptive filter includes a non-linear filter.

4. The device of claim 3, wherein the non-linear filter includes a Wiener filter.

5. The device of claim 1, wherein the trained model includes a neural network.

6. The device of claim 1, wherein the one or more processors are further configured to receive a microphone output signal from a microphone, and wherein the input audio signal is based on the microphone output signal.

7. The device of claim 6, wherein the one or more processors are configured to process, using one or more filters, the microphone output signal to generate the input audio signal.

8. The device of claim 7, wherein the one or more filters include a linear filter.

9. The device of claim 8, wherein the linear filter includes a finite impulse response (FIR) filter.

10. The device of claim 7, wherein the one or more processors are configured to:
obtain mode data indicative of an operation mode; and
select a filter based on the operation mode, wherein the one or more filters include the filter.

11. The device of claim 10, wherein the operation mode indicates whether a window is open, whether wipers of a vehicle are activated, or both.

12. The device of claim 1, wherein the one or more processors are configured to obtain a second input audio signal including at least second speech of a second person, wherein the output audio signal is based at least in part on the second input audio signal.

13. The device of claim 12, wherein the one or more processors are configured to receive a microphone output signal from a microphone, and wherein the microphone output signal and the second input audio signal are processed using one or more filters to generate the input audio signal.

14. The device of claim 12, wherein the input audio signal and the second input audio signal are processed using the trained model to generate the predicted noise signal.

15. The device of claim 12, wherein the second input audio signal is received from a second device.

16. The device of claim 1, wherein the one or more processors are further configured to:
obtain mode data indicative of an operation mode; and
select, based on the operation mode, the trained model from a plurality of trained models to process the input audio signal.

17. The device of claim 1, wherein the one or more processors are further configured to selectively adjust weights of a time-frequency mask based on a criterion, and wherein the one or more processors are configured to process the input audio signal using the trained model by applying the time-frequency mask to the input audio signal to generate the predicted noise signal.

18. The device of claim 17, wherein the criterion is based on determining whether the output audio signal is to be used for automated speech recognition.

19. A method comprising:
obtaining, at a device, an input audio signal including at least first speech of a first person;
generating, at the device, a predicted noise signal based on processing of the input audio signal by a trained model; and
subtracting, at the device, the predicted noise signal from the input audio signal to generate an output audio signal.

20. The method of claim 19, wherein generating the predicted noise signal includes:
processing, using the trained model, the input audio signal to generate an intermediate predicted noise signal; and
processing, using an adaptive filter, the intermediate predicted noise signal to generate the predicted noise signal.

21. The method of claim 20, wherein the adaptive filter includes a non-linear filter.

22. The method of claim 21, wherein the non-linear filter includes a Wiener filter.

23. The method of claim 19, wherein the trained model includes a neural network.

24. The method of claim 19, further comprising receiving a microphone output signal from a microphone, wherein the input audio signal is based on the microphone output signal.

25. The method of claim 24, further comprising processing, using one or more filters, the microphone output signal to generate the input audio signal.

26. The method of claim 25, wherein the one or more filters include a linear filter.

27. A non-transitory computer-readable medium storing instructions that, when executed by one or more processors, cause the one or more processors to:
obtain an input audio signal including at least first speech of a first person;
generate a predicted noise signal based on processing of the input audio signal by a trained model; and
subtract the predicted noise signal from the input audio signal to generate an output audio signal.

28. The non-transitory computer-readable medium of claim 27, wherein the instructions, when executed by the one or more processors, further cause the one or more processors to obtain a second input audio signal including at least second speech of a second person, wherein the output audio signal is based at least in part on the second input audio signal.

29. An apparatus comprising:
means for obtaining an input audio signal including at least first speech of a first person;
means for generating a predicted noise signal based on processing of the input audio signal by a trained model; and
means for subtracting the predicted noise signal from the input audio signal to generate an output audio signal.

30. The apparatus of claim 29, wherein the means for obtaining, the means for generating, and the means for subtracting are integrated into at least one of a smart speaker, a speaker bar, a smart phone, a computer, a display device, a television, a gaming console, a music player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a mobile device, or any combination thereof.
